(19) United States
(12) Patent Application Publication
(10) Pub. No.: US 2026/0018359 A1
(43) Pub. Date: Jan. 15, 2026

(54) Actuator for a Circuit Breaker in a Switchgear

(71) Applicant: ABB Schweiz AG, Baden (CH)

(72) Inventors: S Chiplunkar, Nashik (IN); Bhalchandra Varade, Nashik (IN); Vikas Jakate, Nashik (IN); V Ramesh, Nashik (IN)

(73) Assignee: ABB Schweiz AG, Baden (CH)

(21) Appl. No.: 19/262,699

(22) Filed: Jul. 8, 2025

(30) Foreign Application Priority Data
Jul. 10, 2024 (IN) 202441052682

(51) Int. Cl. H01H 71/32

(52) U.S. Cl. CPC H01H 71/322; H01H 71/325

(57) ABSTRACT

An actuator for a circuit breaker in a switchgear includes a housing, an actuating shaft, at least one armature, and at least three windings. The housing is defined with a bore along a longitudinal axis of the housing. The bore of the housing facilitates displacement of the actuating shaft within the bore. The actuating shaft is connectable to an electrical component of a circuit breaker. On selective energization of the at least three windings, the at least one armature connected to the actuating shaft is configured to be displaced within the bore to facilitate multiple stage-based configuration of the actuator.

### CROSS-REFERENCE TO RELATED APPLICATIONS

The instant application claims priority to Indian Patent Application number 202441052682, filed Jul. 10, 2024, which is incorporated herein in its entirety by reference.

### FIELD OF THE DISCLOSURE

The present disclosure generally relates to electrical switchgear in an electrical power system and, more particularly, to an actuator for a circuit breaker in a switchgear cabinet of the electrical switchgear.

### BACKGROUND OF THE INVENTION

The application of electrical switchgear has been widely used in electrical power distribution systems, which allows distribution of electrical power and also isolates electrical loads. Generally, switchgear comprises a combination of electrical components such as disconnectors, actuators, fuses, circuit breakers, and a main distribution of a busbar. Switch gears are applicable where there is a requirement of protecting, isolating, or distributing electrical power.

Circuit breakers are used for the safety of an electrical system from damage due to flow of high magnitude current or short circuits. The circuit breakers interrupt abnormal or faulty currents. Circuit breakers are available in the markets with their wide range of applications to protect against damage to the electrical systems from both low and high-voltage currents. The circuit breaker has a vacuum interrupter and an isolator, connected in a combination. The vacuum interrupter provides a faster interruption of current. The disconnector or an isolator is a mechanical switch that provides an isolating distance with specific requirements, in an open position. The disconnector is capable of opening and closing a circuit when negligible current is broken or made, or when no significant change in voltage across terminals of disconnectors occurs. Under normal circuit conditions, the disconnectors can carry currents and in abnormal conditions, the disconnectors carry current for a specific time, such as in conditions of short-circuit.

When a line of circuit is disconnected, an earthing switch is closed to discharge voltage trapped on the line. At indoor or outdoor substation, components such as circuit breakers, disconnectors and earthing switches are three components that are used to trip, isolate and earthen the substation in case of fault or during maintenance.

Conventionally, for two separate functions like of circuit breaker and the disconnector, there is a requirement of two separate actuators. This stated technical aspect as well another aspect of construction that all three components, circuit breaker, disconnector, and earthing switch being three separate units make overall size of the substation considerable size leading to occupy more space. Two separate actuators for the disconnector and the circuit breaker tend to make the substation system bulkier.

Along with the limitations mentioned above, actuators currently are configured to be used for single stage operation and other configurations may make the switchgear bulkier leading to size constraints. Another aspect is the complexity, which is a result of such bulkier switchgear and it may require more maintenance time due to its complex functionality.

The information disclosed in this background of the disclosure section is only for enhancement of understanding of the general background of the invention and should not be taken as an acknowledgement or any form of suggestion that this information forms the prior art already known to a person skilled in the art.

### BRIEF SUMMARY OF THE INVENTION

One or more shortcomings of assembly, systems are overcome, and additional advantages are provided through the assembly and the system as claimed in the present disclosure. Additional features and advantages are realized through the techniques of the present disclosure. Other embodiments and aspects of the disclosure are described in detail herein and are considered a part of the claimed disclosure.

In one non-limiting embodiment of the disclosure, an actuator for a circuit breaker is disclosed. The actuator includes a housing, an actuating shaft, a least one armature, and at least three windings. The housing is defined with a bore along a longitudinal axis of the housing. The actuating shaft is movably positioned in the bore and extends along the longitudinal axis of the housing. At least one end of the actuating shaft is connectable to an electrical component of a circuit breaker. The at least one armature is connected to the actuating shaft and is configured to displace within the bore. The at least three windings, each positioned in at least one through a slot of a plurality of through slots defined in the housing.

Each of the at least three windings is configured to be selectively energized to displace the at least one armature.

### BRIEF DESCRIPTION OF THE SEVERAL VIEWS OF THE DRAWING(S)

FIG. 1 is a perspective view of an actuator for a circuit breaker in a switchgear, in accordance with embodiments of the disclosure.

FIG. 2 is a perspective view of a housing of the actuator of FIG. 1.

FIG. 3 is another perspective view of the actuator of FIG. 1.

FIG. 4 is a side view of the actuator of FIG. 1.

FIG. 5 is another perspective view of the actuator of FIG. 1, which includes at least one armature, in accordance with embodiments of the disclosure.

FIG. 6 is a front view of at least three windings with the actuator of FIG. 5.

FIG. 7 is a front view of an actuating shaft of the actuator of FIG. 1.

### DETAILED DESCRIPTION OF THE INVENTION

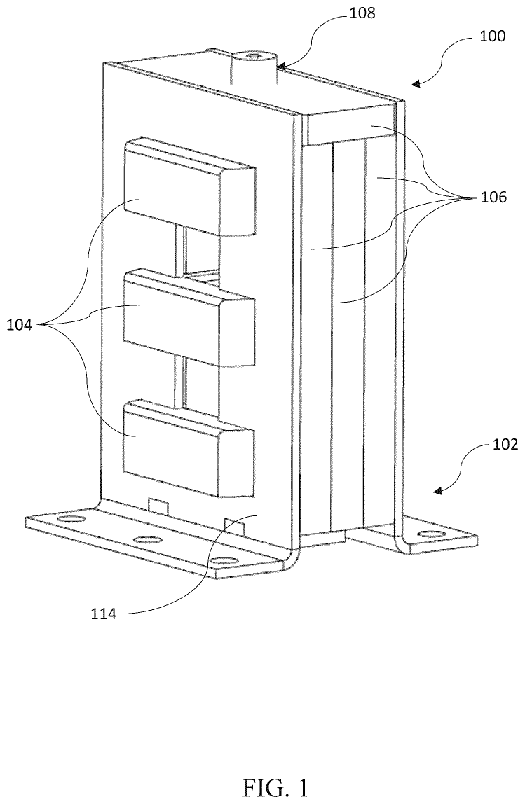

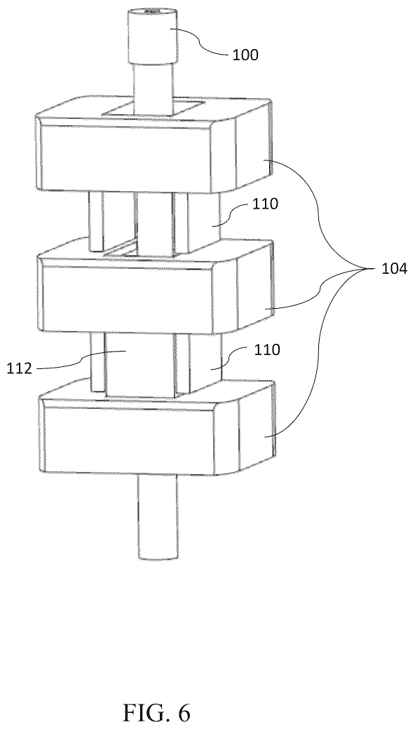

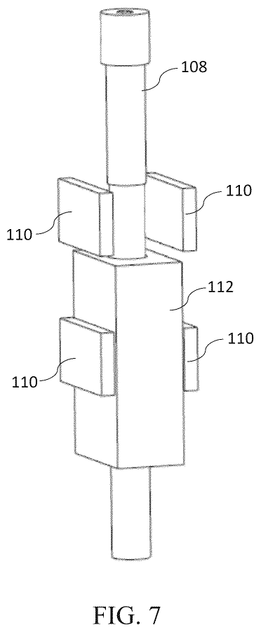

The following paragraphs describe the present disclosure with reference to FIGS. 1 to 7. In the figures, the same element or elements which have similar functions are indicated by the same reference signs. For promoting an understanding of the principles of the disclosure, reference will now be made to specific embodiments illustrated in the drawings and specific language will be used to describe the same. It will nevertheless be understood that no limitation of the scope of the invention is thereby intended, such alterations and further modifications in the illustrated system or device, and such further applications of the principles of the invention as illustrated, therein being contemplated as would normally occur to one skilled in the art to which the disclosure pertains.

The following detailed description is merely exemplary in nature and is not intended to limit application and uses. Further, there is no intention to be bound by any theory presented in the preceding background or summary or the following detailed description. It is to be understood that the disclosure may assume various alternative orientations and step sequences, except where expressly specified to the contrary. It is also to be understood that the specific devices or components illustrated in the attached drawings and described in the following specification are simply exemplary embodiments of the inventive concepts defined in the appended claims. Hereinafter, preferred embodiments of the present disclosure will be described referring to the accompanying drawings. While some specific terms directed to a specific direction will be used, the purpose of usage of these terms or words is merely to facilitate understanding of the present invention referring to the drawings.

Accordingly, it should be noted that meaning of these terms or words should not improperly limit the technical scope of the present invention. Also, it is to be understood that the phraseology and terminology used herein is for the purpose of description and should not be regarded as limiting. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. It is to be understood that this disclosure is not limited to the specific devices, methods, applications, conditions, or parameters described and/or shown herein, and that the terminology used herein is for the purpose of describing particular embodiments by way of example and is not intended to be limiting of the claimed invention. In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

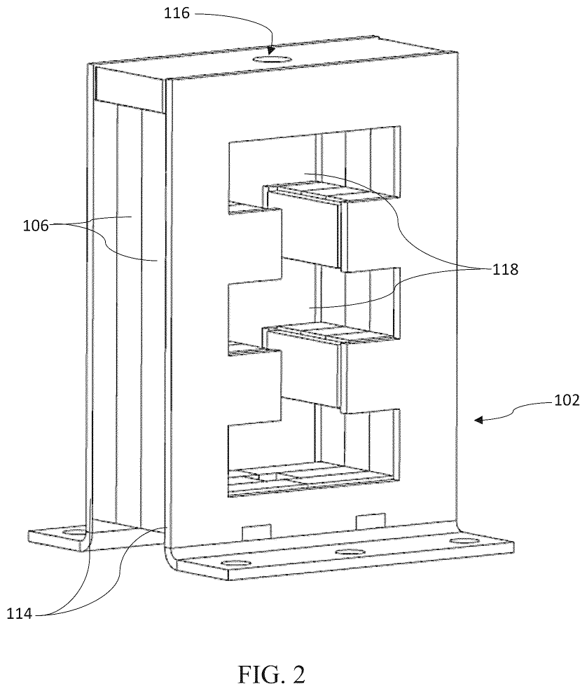

Referring to FIGS. 1 and 2 in conjunction, an actuator for a circuit breaker in a switchgear is illustrated. The switchgear of the disclosure may comprise a low voltage compartment (not shown explicitly), a cable compartment (not shown explicitly), a load side power line (not shown explicitly), a line side power line (not shown explicitly), and a circuit breaker compartment (not shown explicitly). The circuit breaker compartment of the disclosure may removably accommodate a circuit breaker (not shown explicitly). The circuit breaker may be configured to be engaged to the load side power line through a load terminal. The circuit breaker may be configured to be engaged with the line side power line through a line terminal. The circuit breaker of the disclosure may also comprise a ground terminal, an interruption assembly, and an actuator (100).

The interruption assembly may comprise an interrupter (not shown explicitly). The interrupter may be selectively displaced between each of the line terminal, the load terminal and the ground terminal to displace the circuit breaker between an ON condition, an OFF condition, and an earth condition. The interruption assembly may include a fixed contact module and a movable contact module.

The actuator (100) disclosed in the disclosure may be operatively associated with the circuit breaker to facilitate the functioning of the circuit breaker (not shown explicitly) in an effective manner as the disclosure intends to perform. The actuator (100) of the disclosure may be defined with a housing (102) as its foundational element that mounts or houses different elements that may be disclosed in forthcoming embodiments of the disclosure. The housing (102) of the actuator (100) may be defined as a body formed of a plurality of laminates (106) stacked adjacent to each other. The stacking of the plurality of laminates (106) may be supported by a plurality of supporting elements (114). In an embodiment, two supporting elements (114) may be configured to stack or secure the plurality of laminates (106) therebetween. The plurality of supporting elements (114) may be understood as rectangular-shaped plates that may be configured to be coupled with each other and being separated by the plurality of laminates (106) therebetween. The plurality of laminates (114) may be made from a polymeric material offering desirable dielectric strength and mechanical resistance during the operation of the circuit breaker.

The housing (102) may be a solid block that may withstand shocks, wear and tear and may still perform its operation without compromising on its structural aspects. The housing (102) may be defined with a bore (116). The bore (116) may be understood as a hollow provision positioned at a central portion of the housing (102) and along a longitudinal axis (A-A) of the housing (102). The bore (116) may not be limited to be a cylindrically shaped provision, or a rectangular-shaped provision, rather the bore (116) may be shaped in different shapes to accommodate an actuating shaft (108) therein. The actuating shaft (108) may be positioned to be extended inside the bore (116) along the longitudinal axis (A-A) of the housing (102).

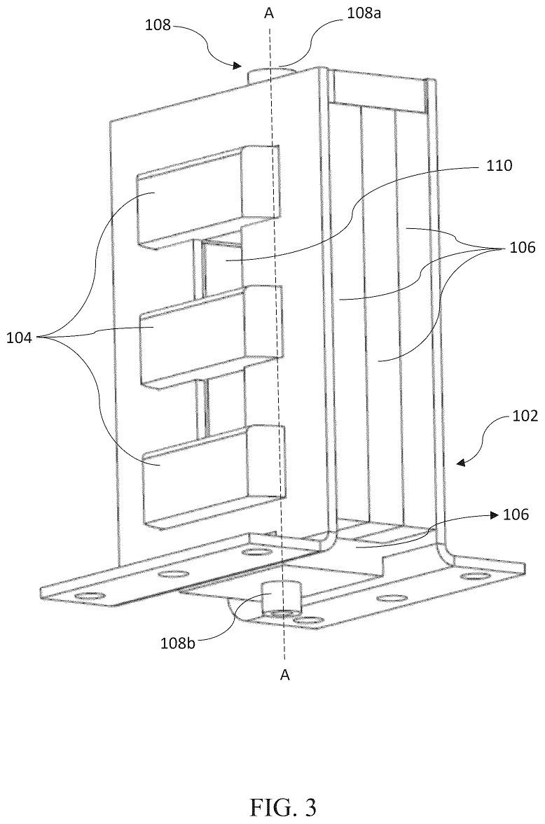

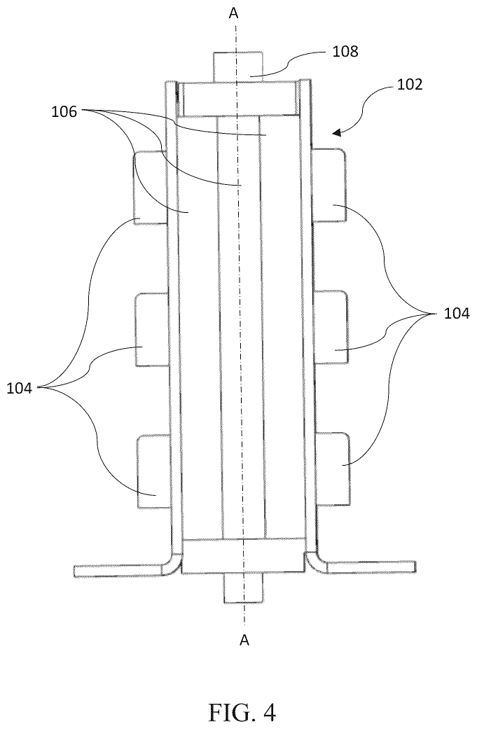

Referring to FIG. 3-FIG. 4, the actuating shaft (108) may be configured to be connectable to an electrical component of the circuit breaker (described earlier), through at least one end (108a, 108b). The electrical component in the circuit breaker may be a series disconnector. The actuating shaft (108) of the disclosure may be facilitated to be displaced within the bore (116) in different stages to allow multiple stage-based configurations to the actuator (100) of the disclosure. To allow facilitation of different stages configuration in a selective manner, the actuating shaft (108) may be connected to at least one armature (112).

The armature (112) may be configured to be displaced within the bore (116) of the housing (102).

The housing (102) of the actuator (100) may also be defined with a plurality of through slots (118). The plurality of through slots (118) may be defined equidistantly from one another along the longitudinal axis (A-A) and may extend perpendicularly to the longitudinal axis (A-A). The plurality of slots (118) may accommodate at least three windings (104). The at least three windings (104) may be positioned in at least one through slot of the plurality of through slots (118) defined in the housing (102). Each winding of the at least three windings (104) may be defined with an opening corresponding to the bore (116) of the housing (102). Each winding of the at least three windings (104) may facilitate encompassing of the actuating shaft (108) and the at least one armature (112). Each winding of the at least three windings (104) may be configured to be selectively energized in order to displace the at least one armature (112) connected to the actuating shaft (108). The actuating shaft (108) of the disclosure may be configured to be connected to the electrical component of the circuit breaker through an operating lever (not shown explicitly). In an embodiment, the displacement of the armature (112) connected to the actuating shaft (108) may in turn actuate the operating lever of the disclosure. This configuration may allow the actuating shaft (112) of the disclosure to be in an operative state with the electrical component to further switch the circuit breaker selectively between an ON condition, an OFF condition, and an earth condition.

The selective energization of a winding of the at least three windings (104) may convert the particular winding of the at least three windings (104) into an electromagnet. Therefore, on being energized, a particular winding of the at least three windings (104) may actuate the actuating shaft (112) to displace it within the bore (116) into multiple stage-based configurations achievable by the actuator (100). The said selective energization of a particular winding of the at least three windings (104) may displace the armature (112) towards the energized particular winding of the at least three windings (104) for operation of the actuating shaft (108) between the ON condition, OFF condition, and the earth condition.

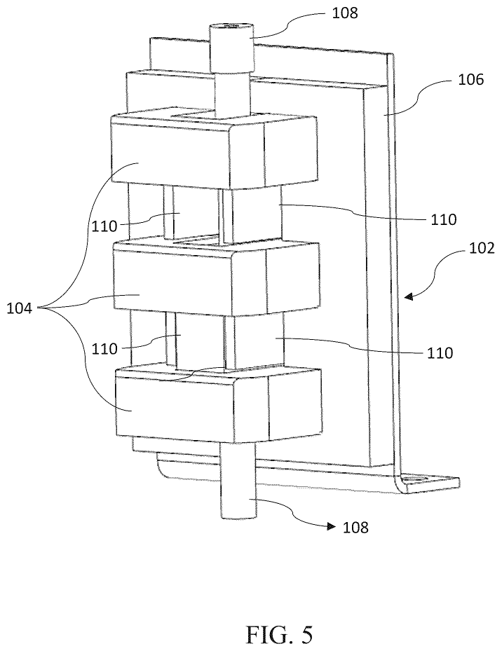

With reference to FIG. 5-FIG. 7, as described in earlier embodiments, the actuator (100) of the disclosure may provide a multiple-stages based configuration for selective operation of the actuator (100) for the circuit breaker in a switchgear. The displacement of the actuating shaft (108) within the bore (116) may selectively actuate to a pre-defined level or stage due to a resistance mechanism that offers resistance to higher or lower movement of the armature (112), enabling the state of a stay of the armature (112) in a pre-defined position within the bore (116). For such purposes, the actuator (100) may comprise at least one permanent magnet (110). The at least one permanent magnet (110) may be a rectangular-shaped element, but such constructional aspect may not be considered as a limitation, rather the shape of the at least one permanent magnet (110) may be adaptable to be compact to allow operation of the actuator (100) with its space constraint. The at least one permanent magnet (110) may be disposed between adjacent windings of the at least three windings (104).

After energization of a particular winding of the at least three windings (104), the armature (112) connected to the actuating shaft (108) may be displaced to traverse within the bore (116). The at least one permanent magnet (110) may be positioned in a manner between two adjacent windings (104) of the at least three windings (104) that it may restrict further movement of the armature (112) in any direction along the longitudinal axis (A-A) of the housing (102). The armature (112) may be configured to be positioned between two adjacent windings of the at least three windings (104) enabling a selective actuation of the circuit breaker. The selective actuation of the armature (112) between different levels/positions pre-defined in the actuator (100) may assist in selective actuation of the operating lever (not shown) mentioned earlier. The selective actuation of the operating lever may provide more stability, conciseness and effective operation of the actuator (100) while its operation in the circuit breaker.

The embodiments of the disclosure may provide a multiple stage-based selective actuation of the actuator (100) of the circuit breaker in a switchgear. The embodiments disclosed in the disclosure may drive vacuum interrupters with a disconnector and earthing switch in multiple-stage operation. The actuator (100) disclosed in the embodiments of the disclosure may provide a compact constructional aspect to overall size of the substation systems. This may further provide better space management with an effective multiple stage-based configuration of the actuator (100).

In an embodiment of the disclosure, the bore is defined at a substantially central portion of the housing along the longitudinal axis.

In an embodiment of the disclosure, shaft is connectable to the electrical component of the circuit breaker through an operating lever.

In an embodiment of the disclosure, the actuating shaft is configured to operate the electrical component for switching the circuit breaker selectively between ON condition, OFF condition, and earth condition.

In an embodiment of the disclosure, the plurality of through slots are defined equidistantly form one another and extending perpendicular to the longitudinal axis.

In an embodiment of the disclosure, each of the at least three windings is defined with an opening corresponding to the bore in the housing and encompassing the actuating shaft and the at least one armature.

In an embodiment of the disclosure, the housing is a solid block.

In an embodiment of the disclosure, the housing is formed of a plurality of laminates stacked adjacent to each other.

In an embodiment of the disclosure, the actuator includes at least one permanent magnet disposed between adjacent windings of the at least three windings.

In an embodiment of the disclosure, each of the at least three windings is selectively energized to displace the at least one armature towards an energized winding in turn displacing the actuating shaft to operate the electrical component of the circuit breaker for switching the circuit breaker selectively between the ON condition, the earth condition and the OFF condition. Selectively energizing each of the at least three windings convert the energized winding of the at least three windings to an electromagnet.

In an embodiment of the disclosure, the electrical component in the circuit breaker is a series disconnector.

In another non-limiting embodiment of the disclosure, a circuit breaker is disclosed. The circuit breaker includes a line terminal, a load terminal, a ground terminal, an interruption assembly and an actuator. The interruption assembly includes an interrupter being adapted to selectively displace between each of, the line terminal, the load terminal and the ground terminal. The actuator is operatively coupled to the interruption assembly. The actuator includes a housing, an actuating shaft, a least one armature, and at least three windings. The housing is defined with a bore along a longitudinal axis of the housing. The actuating shaft is movably positioned in the bore and extends along the longitudinal axis of the housing. At least one end of the actuating shaft is connectable to an electrical component of a circuit breaker. The at least one armature is connected to the actuating shaft and is configured to displace within the bore. The at least three windings, each positioned in at least one through slot of a plurality of through slots defined in the housing. Each of the at least three windings is configured to be selectively energized to displace the at least one armature.

In an embodiment of the disclosure, the at least three windings include an opening winding, a supportive winding, and a closing winding.

In an embodiment of the disclosure, the at least one armature is displaced to a first stage by the supporting winding of the at least three windings to operate the interrupter to the OFF condition, wherein in the OFF condition, the interrupter is isolated from the load terminal and the ground terminal.

In an embodiment of the disclosure, the at least one armature (112) is displaced to a second stage from the first stage by at least one of the opening winding and the closing winding of the at least three windings (104) to selectively operate the interrupter to the ON condition and the earth condition, wherein the interrupter in the ON condition engages with the load terminal to permit flow of electrical current through the circuit breaker and the interrupter in the earth condition engages with the ground terminal to ground the circuit breaker.

In yet another non-limiting embodiment of the present disclosure, a switchgear is disclosed. The switchgear includes a low voltage compartment, a cable compartment, a load side power line, a line side power line and a circuit breaker compartment. The circuit breaker removably accommodates a circuit breaker connectable to the load side power line and the line side power line. The circuit breaker includes a line terminal engageable with the line side power line, a load terminal engageable with the load side power line, a ground terminal, an interruption assembly, and an actuator. The interruption assembly includes an interrupter. The interrupter is adapted to adapted to selectively displaceable between each of the line terminal, the load terminal and the ground terminal to displace the circuit breaker between ON condition, OFF condition and earth condition. The interruption assembly is defined within a vacuum chamber. The interruption assembly comprising a fixed contact module, and a movable contact module. The actuator includes a housing, an actuating shaft, a least one armature, and at least three windings. The housing is defined with a bore along a longitudinal axis of the housing. The actuating shaft is movably positioned in the bore and extends along the longitudinal axis of the housing. At least one end of the actuating shaft is connectable to an electrical component of a circuit breaker. The at least one armature is connected to the actuating shaft and is configured to displace within the bore. The at least three windings, each positioned in at least one through slot of a plurality of through slots defined in the housing. Each of the at least three windings is configured to be selectively energized to displace the at least one armature.

The foregoing summary is illustrative only and is not intended to be in any way limiting. In addition to the illustrative aspects, embodiments, and features described above, further aspects, embodiments, and features will become apparent by reference to the drawings and the following detailed description.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SYMBOLS

Actuator 100
Housing 102
Windings 104
Laminates 106
Actuating shaft 108
Ends of actuating shaft 108a, 108b
Permanent magnet 110
Armature 112
Supporting elements 114
Bore 116
Slots 118

What is claimed is:

1. An actuator for a circuit breaker, the actuator comprising:
a housing including a bore defined along a longitudinal axis of the housing.
an actuating shaft movably positioned in the bore and extending along the longitudinal axis of the housing, wherein at least one end of the actuating shaft is connectable to an electrical component of a circuit breaker;
at least one armature connected to the actuating shaft and being configured to displace within the bore; and
at least three windings, each positioned in at least one through slot of a plurality of through slots defined in the housing;
wherein each of the at least three windings is configured to be selectively energized to displace the at least one armature.

2. The actuator of claim 1, wherein the bore is defined at a substantially central portion of the housing along the longitudinal axis.

3. The actuator of claim 1, wherein the actuating shaft is connectable to the electrical component of the circuit breaker through an operating lever.

4. The actuator of claim 1, wherein the actuating shaft is configured to operate the electrical component for switching the circuit breaker selectively between an ON condition, an OFF condition, and an earth condition.

5. The actuator of claim 1, wherein the plurality of through slots is defined equidistantly form one another and extends perpendicular relative to the longitudinal axis.

6. The actuator of claim 1, wherein each of the at least three windings is defined with an opening corresponding to the bore in the housing and encompassing the actuating shaft and the at least one armature.

7. The actuator of claim 1, wherein the housing is a solid block.

8. The actuator of claim 1, wherein the housing is formed of a plurality of laminates stacked adjacent to each other.

9. The actuator of claim 1, further comprising at least one permanent magnet disposed between adjacent windings of the at least three windings.

10. The actuator of claim 4, wherein each of the at least three windings is selectively energised to displace the at least one armature towards an energised winding in turn displacing the actuating shaft to operate the electrical component of the circuit breaker for switching the circuit breaker selectively between the ON condition, the earth condition and the OFF condition, and wherein selectively energizing each of the at least three windings converts the energized winding of the at least three windings to an electromagnet.

11. The actuator of claim 1, wherein the electrical component in the circuit breaker is a series disconnector.

12. A circuit breaker, comprising:
a line terminal;
a load terminal;
a ground terminal;
an interruption assembly comprising an interrupter being adapted to selectively displace between each of, the line terminal, the load terminal and the ground terminal; and
an actuator operatively coupled to the interruption assembly, the actuator comprising:
a housing defined with a bore along a longitudinal axis of the housing;
an actuating shaft movably positioned in the bore and extending along the longitudinal axis of the housing, the actuating shaft having at least one end that is connected to the interrupter for switching the circuit breaker selectively between an ON condition, an OFF condition, and an earth condition;
at least one armature connected to the actuating shaft and being configured to displace within the bore; and
at least three windings, each positioned in at least one slot of a plurality of through slots defined in the housing), wherein each of the at least three windings being configured to be selectively energized to displace the at least one armature.

13. The circuit breaker of claim 12, wherein the bore is defined at a substantially central portion of the housing along the longitudinal axis.

14. The circuit breaker of claim 12, wherein the actuating shaft is connectable to the interrupter of the circuit breaker through an operating lever.

15. The circuit breaker of claim 12, wherein the plurality of through slots is defined equidistantly form one another along the longitudinal axis and extends perpendicularly relative to the longitudinal axis.

16. The circuit breaker of claim 12, wherein each of the at least three windings is defined with an opening corresponding to the bore in the housing and encompassing the actuating shaft and the at least one armature disposed in the bore.

17. The circuit breaker of claim 12, wherein the housing is a solid block.

18. The circuit breaker of claim 12, wherein the housing is formed of a plurality of laminates stacked adjacent to each other.

19. The circuit breaker of claim 12, wherein the actuator comprises at least one permanent magnet disposed between adjacent windings of the at least three windings.

20. The circuit breaker of claim 12, wherein each of the at least three windings is selectively energized to displace the at least one armature towards an energized winding, which in turn displaces the actuating shaft to operate the interrupter of the circuit breaker for switching the circuit breaker selectively between the ON condition, the earth condition, and the OFF condition, and wherein selectively energizing each of the at least three windings converts the energised winding of the at least three windings to an electromagnet.

21. The circuit breaker of claim 12, wherein the at least three windings include an opening winding, a supporting winding, and a closing winding.

22. The circuit breaker of claim 12, wherein the at least one armature is displaced to a first stage by the supporting winding of the at least three windings to operate the interrupter to the OFF condition, and wherein in the OFF condition, the interrupter is isolated from the load terminal and the ground terminal.

23. The circuit breaker of claim 12, wherein the at least one armature is displaced to a second stage from the first stage by at least one of the opening winding and the closing winding of the at least three windings to selectively operate the interrupter to the ON condition and the earth condition, wherein the interrupter in the ON condition engages with the load terminal to permit flow of electrical current through the circuit breaker and the interrupter in the earth condition engages with the ground terminal to ground the circuit breaker.

24. A switchgear comprising,
a low voltage compartment;
a cable compartment;
a load side power line;
a line side power line;
a circuit breaker compartment removably accommodating a circuit breaker connectable to the load side power line and the line side power line, the circuit breaker comprising:
a line terminal engageable with the line side power line;
a load terminal engageable with the load side power line;
a ground terminal;
an interruption assembly comprising an interrupter being adapted to selectively displaceable between each of the line terminal, the load terminal and the ground terminal to displace the circuit breaker between ON condition, OFF condition and earth condition, the interruption assembly defined within a vacuum chamber, the interruption assembly comprising a fixed contact module, and a movable contact module; and
an actuator operatively associated with the circuit breaker, the actuator comprising:
a housing defined with a bore along a longitudinal axis of the housing;
an actuating shaft movably positioned in the bore and extending along the longitudinal axis of the housing, at least one end of the actuating shaft being connectable to the interrupter for switching the circuit breaker selectively between ON condition, OFF condition, and earth condition; and
at least one armature connected to the actuating shaft and being configured to displace within the bore; and
at least three windings, each positioned in at least one slot of a plurality of through slots defined in the housing, wherein each of the at least three windings is configured to be selectively energized to displace the at least one armature.
